(19) United States
(12) Patent Application Publication
(10) Pub. No.: US 2018/0154266 A1
(43) Pub. Date: Jun. 7, 2018

(54) FANTASY-STYLED, HORSE RACING GAME COMBINING THOROUGHBRED HANDICAPPING AND PARI-MUTUEL WAGERING, AND SYSTEM AND METHOD USING SAME

(71) Applicant: StableDuel, LLC, Kew Gardens, NY (US)

(72) Inventors: AUGUST GREINER, JR., Kew Gardens, NY (US); CHRISTOPHER BROTHERS, Kew Gardens, NY (US); PETER ZACCHEA, Kew Gardens, NY (US)

(21) Appl. No.: 15/368,291

(22) Filed: Dec. 2, 2016

(51) Int. Cl. A63F 13/828; A63F 13/792; G07F 17/32

(52) U.S. Cl. CPC A63F 13/828; A63F 13/792; G07F 17/3288; G07F 17/3258; G07F 17/3227

(57) ABSTRACT

A racing scoring game aids in specifying a maximum stable value as an aggregation of pre-race salary values attributable to a predetermined number of race horses. The method and system receive, via a network, pre-race odds for a plurality of horses across a plurality of races. For each horse, a pre-race salary value and a rules selection for a given game exists. Based on an automated point scoring method and odds value determinations, a participant receives race results via a network connection. The method and system determine from race results, a score value for each of the plurality of horses across said plurality of races and an aggregated score value for the first participant stable. The result is a computer-based daily fantasy-styled, horse racing game combining fantasy sports with thoroughbred handicapping and pari-mutuel wagering, together with a system and method for using same.

### FIELD OF THE INVENTION

The present disclosure relates to a computerized fantasy-styled, horse racing game combining thoroughbred handicapping and pari-mutuel wagering, and system and method using same.

### BACKGROUND OF THE INVENTION

In recent years, a new form of sports participation, fantasy sports, has emerged with great success. Online fantasy sports are a multibillion-dollar industry. A fantasy sport is a type of online game of skill where participants assemble imaginary or virtual teams of real players of a professional sport. These teams compete based on the statistical performance of those participants' players in actual games. This performance is converted into points that are compiled and totaled according to a roster selected by each fantasy team's manager. These point systems can be simple enough to be manually calculated by a “league commissioner” who coordinates and manages the overall league, or points can be compiled and calculated using computers tracking actual results of the professional sport. In fantasy sports, team owners draft, trade and cut (drop) players, analogously to real sports.

A study conducted by the FSTA in 2013, showed 33.5 million people age 12 and above in the U.S. with the 2011 FSTA Study showing 3.1 million people in Canada played fantasy sports. A 2006 study showed 22 percent of U.S. adult males 18 to 49 years old, with Internet access, play fantasy sports. Fantasy Sports is estimated to have a $3-$4 Billion annual economic impact across the sports industry. Since 2011, yearly non-betting fantasy sports users have grown 25%. And with the help of media and the growing fantasy sports market, daily fantasy sports leagues FanDuel and DraftKings were able to generate over 300 million dollars in investments from companies like Comcast, NBC Sports, and Time Warner. The new development of daily fantasy sports is where major growth can be seen, “ . . . the daily fantasy spending is where the numbers jump: $257 per year in 2015, while players only spent $5 in 2012.”

Presently, because of high levels of state and federal legal regulation, fantasy sports have failed to grow in sports relying on a pari-mutuel wagering business model as the principal way for participants to engage in the professional sport. Pari-mutuel betting (from the French: Pari Mutuel or mutual betting) is a betting system in which all bets of a particular type are placed together in a pool; taxes and the “house-take” or “vigorish” are removed, and payoff odds are calculated by sharing the pool among all winning bets.

The pari-mutuel system is used in gambling on horse racing, greyhound racing, jai alai, and all sporting events of relatively short duration in which participants finish in a ranked order. A modified pari-mutuel system is also used in some lottery games.

Pari-mutuel betting differs from fixed-odds betting in that the final payout is not determined until the pool is closed—in fixed odds betting, the payout is agreed at the time the bet is sold. Pari-mutuel gambling is frequently state-regulated, and offered in many places where gambling is otherwise illegal. Pari-mutuel gambling is often also offered at “off track” facilities, where participants may bet on the events without actually being present to observe them in person.

Perhaps the best known industry for pari-mutuel wagering is the thoroughbred horse racing industry. This heavily regulated industry provides the only way that pari-mutuel wagers may access the activity occurring during a thoroughbred horse racing event, such as the Kentucky Derby or other race. There are several ways in which a person may place a wager on a thoroughbred horse race. The most popular are: at the track that hosts the races to be run, another racetrack or “Off Track Betting” (OTB) facility via simulcast wagering, and through an “Advance Deposit Wagering” (ADW) company via computer, smartphone, etc. In thoroughbred horse racing, an advanced deposit wagering (ADW) company contracts with a racetrack to provide the means by which horse race spectators may wager on the racing horses for a day's event. ADW companies may provide an interface and the actual content of a racing event. Within the past few years ADW companies have increased in popularity with pari-mutuel bettors and are the most popular method to place such a wager on thoroughbred horse races.

Some ADW companies may provide a pseudo fantasy type of game. Such a game may be similar to a normal horse race, whereby the ADW company may provide a participant the ability to pick the winners of these 5 or 6 races at a thoroughbred race track. The ADW company may also provide these options. In fact, some ADW sites may allow a participant to pick a horse in the races of an event. These companies will tally up how much money the horses win based on the pari-mutuel payout and at the end of the day, whoever has the most money in their hypothetical pari-mutuel pool wins the contest.

Similarly, there have been various attempts by ADWs and pari-mutuel venues to entice individuals who are attracted to simple wagering activities or the potential for a larger payout. For example, random wagers, sometimes referred to as “quick picks”, have been offered at pari-mutuel venues to satisfy patrons favoring simple wagers. However, those individuals may feel disadvantaged by the fact that other bettors are actively handicapping their wagers and, therefore, may have a better chance at winning a portion of the wagering pool.

Attempts have also been made to attract individuals inclined to participate in wagering activities offering forms of direct competition with other bettors. For example, pari-mutuel venues have periodically offered handicapping tournaments wherein a bettor enters the contest and pays an entry fee by which a specified number of participants may compete with one another for a preselected distribution of the cumulative sum of the entry fees, prizes, or both.

However, because of regulatory constraints and other limitations, fantasy sports have generally failed to succeed in the thoroughbred horse racing industry. No known method and system exists whereby a participant may convert a salary cap for a stable of horses. No known method or system allows a participant pick horses as a function of salaries for each horse to form a stable through which the participant may compete in a manner similar to other fantasy sports.

In addition to the fact that no known fantasy horse racing game provides the ability to engage in pari-mutuel wagering, there is no known horse racing game that considers both the finishing position the horses in a race, as well as the position of the horse relative to the other horses at the finish.

Accordingly, a need exists for a fantasy-styled, horse racing game combining thoroughbred handicapping and pari-mutuel wagering, and system and method using same.

In view of the shortcomings in the art and needs attendant thereto, the inventors herein have recognized that it would be advantageous to provide a method and system for wagering attractive to patrons desiring an easily perceptible potential for large jackpots and greater predictability in providing betting opportunities or entertainment for an extended period of time, while satisfying the patrons' desire to actively compete against other bettors in a prize environment structured differently than that associated with conventional pari-mutuel wagering and, optionally, in association with conventional pari-mutuel wagering.

More specifically, the inventors herein have recognized that it would be desirable to provide a wagering activity in which a small entry fee makes players eligible for significant cash or merchandise prizes over an extended gaming period. It would also be desirable to provide a wagering activity that would support individual competition, as well as competition among teams or groups formed on an ad-hoc basis in betting locations, and that would provide real time competition among participants. It would further be desirable to provide a wagering activity that accurately simulates the underlying game, in which players can track their own performances relative to the performances of competing players or teams and in which winners are defined and determined by variable criteria that provides flexibility, variety, and entertainment. Other desirable aspects for a wagering activity would be the capability to link players from around the country or around the world in a common direct competition.

To enhance entertainment value in a responsible fashion, the inventors, herein have recognized that it would be desirable to provide a wagering activity that provides participants an element of “fantasy” by providing game players a “salary cap” in order to select their stable of horses.

One desirable implementation of a wagering activity would permit the prize pool to be allocated on a pari-mutuel basis as a percentage of sales (wagers), but also possess the flexibility necessary to easily adjust specific prizes in order to provide variety and capture the interest of various demographics.

### BRIEF SUMMARY OF THE INVENTION

This summary presents integral concepts in a simplified form as a prelude to the more detailed disclosure that is presented herein. Unless otherwise defined, all terms (including technical and scientific terms) used herein have the same meaning as commonly understood by one of ordinary skill in the art to which this disclosure belongs. It may be further understood that terms, such as those defined in commonly used dictionaries, should be interpreted as having a meaning that is consistent with their meaning in the context of the relevant art and the present disclosure, and may not be interpreted in an idealized or overly formal sense unless expressly so defined herein.

A computerized fantasy-styled, horse racing game combining fantasy sports with thoroughbred handicapping and pari-mutuel wagering, and system and method using same. The present horse racing scoring game aids in specifying a maximum stable value as an aggregation of pre-race salary values attributable to a predetermined number of race horses. The method and system receive, via a network, pre-race odds for a plurality of horses across a plurality of races. Based upon these odds, each horse receives a pre-race salary value. A participant uses pre-race salary values for all horses competing in a horse race for a given day to select a stable of horses. The method and system receive race results for the thoroughbred horse racing event and calculates a score value for each of the horses across the day's races. The method and system further determines an aggregated score value for stables participating in the day's event. The result is a computer-based fantasy-styled, horse racing total for each stable. All of the stables are compared to determine contest winners, with prizes awarded accordingly.

According to one aspect of the present disclosure, there is here shown a method and system for conducting a fantasy-style horse racing game. The fantasy-style horse racing game combines thoroughbred racing with pari-mutuel wagering, allowing a participant to pursue a maximum stable value for an aggregated plurality of pre-race salary values. The method and system receive, via a network, pre-race odds for a plurality of horses across a plurality of races. The method and system convert the pre-race odds to horse salary values. Based on a limit for the stable value and the individual horse salary values, the method and system receive horse selections from a participant who selects all horses for a stable. For a first participant, an aggregated salary value results for the first participant stable. For the nth participant, the method and system determine an aggregated salary value for the nth participant's stable. And, further the present disclosure determines a highest value stable selected from the first participant stable through nth participant stable and makes an award according to the determined highest value stable.

Descriptions of certain illustrative aspects are described herein in connection with the annexed FIGUREs. These aspects are indicative of various non-limiting ways in which the disclosed subject matter may be utilized, all of which are intended to be within the scope of the disclosed subject matter. Other advantages, emerging properties, and features may become apparent from the following detailed disclosure when considered in conjunction with the associated FIGUREs that are also within the scope of the disclosure.

### BRIEF DESCRIPTION OF THE DRAWINGS

The novel features believed characteristic of the disclosed subject matter may be set forth in any claims that are filed later. The disclosed subject matter itself, however, as well as a preferred mode of use, further objectives, and advantages thereof, may best be understood by reference to the following detailed description of an illustrative embodiment when read in conjunction with the accompanying drawings, wherein:

FIG. 1 shows a process architecture for an exemplary embodiment of the disclosed subject matter;

FIG. 2 illustrates a computer processing system within which the process of the present disclosure may operate;

FIG. 3 depicts the process flow according to one embodiment of the disclosed subject matter;

FIG. 4 presents a chart of points awarded by the presently disclosed subject matter according to the finishing position of horses in a given race;

FIG. 5 separately shows how the present disclosure adjusts scores derived from the finishing position points according to horse finishing margins;

FIG. 6 summarizes the scoring brackets of FIGS. 4 and 5;

FIG. 6A shows an exemplary data sheet, as may be useful by the fantasy-styled horse racing game of the present disclosure;

FIG. 7 presents a salary conversion table for converting odds of horses to salaries for a given race;

FIG. 8 depicts and illustrates potential application of a scoring methodology consistent with the teachings of the present disclosure;

FIG. 9 shows odds for horses scheduled to run on a particular race day for showing an illustrative embodiment of the present disclosure;

FIG. 10 depicts salaries for horses of FIG. 9 as a function of their respective odds; and

FIGS. 11 through 20 present an exemplary stable selection process incorporating the processes, odds, and salaries of FIGS. 7 through 10; and

FIGS. 21 through 30 show how the disclosed subject matter calculates points for a participant stable using the above-described and illustrated principles.

### DETAILED DESCRIPTION OF ILLUSTRATIVE EMBODIMENTS

Reference now should be made to the drawings, in which the same reference numbers are used throughout the different FIGUREs to designate the same components.

The terminology used herein is for the purpose of describing particular embodiments only and is not intended to be limiting. As used herein, the singular forms “a”, “an”, and “the” are intended to include the plural forms as well, unless the context clearly indicates otherwise. It may be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the FIGUREs to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

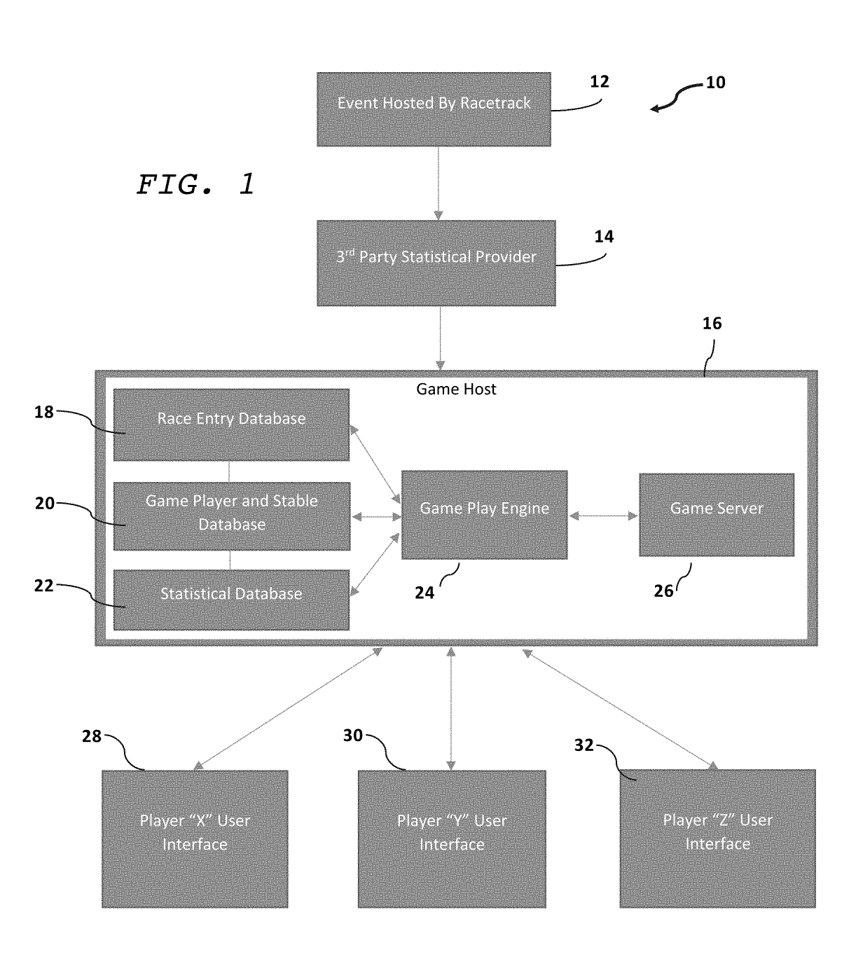

FIG. 1 shows a process architecture for an exemplary embodiment of fantasy-styled, horse racing game 10 the presently disclosed subject matter. Racing game 10 contemplates an event 12 a racetrack may host. Event 12 represents the accumulation of all races that an actual racetrack will provide on a given day and correspond to information processed by the fantasy-styled horse racing game 10. Entries, odds, historical information, and other data relating to individual horses participating in event 12 derive from data presented by a third-party statistical provider 14. Game host 16 provides a race entry database 18 in association with a game participant and stable database 20, which further associates with a statistical database 22. Race entry database 18, game participant and stable database 20, and statistical database 22 further communicate with game play engine 24. In operation, game play engine communicates with game server 26 for providing the computational power for game host 16. Participants “X,” “Y,” and “Z” access game host 10 via participants to accessing game host play fantasy-styled horse racing game 10 through game host 16,

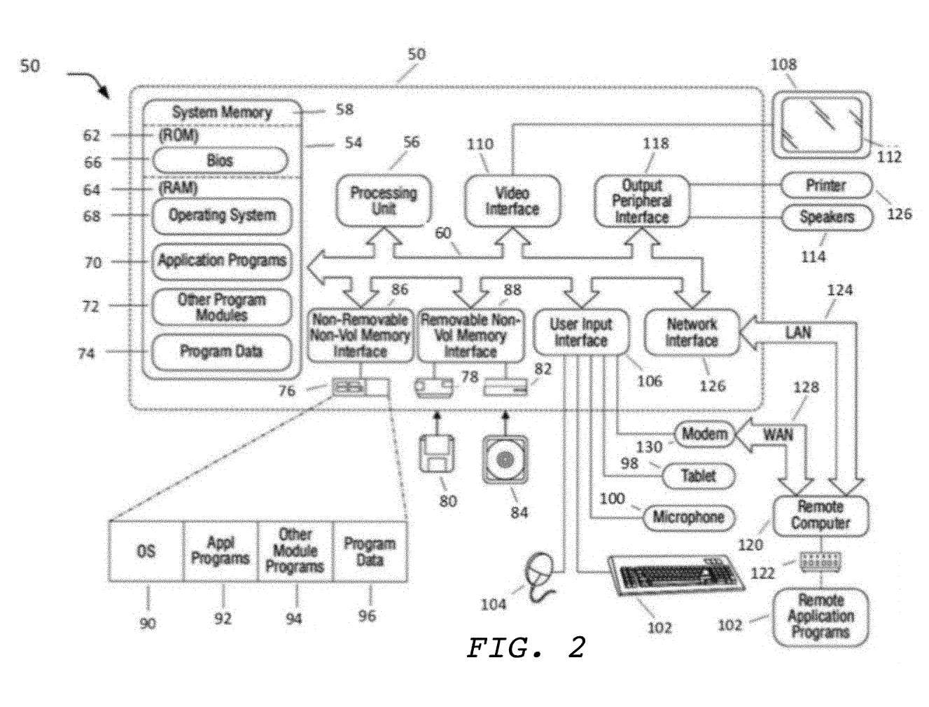

FIG. 2 illustrates a computer processing system within which the process of the present disclosure may operate. The data capture, analysis, and use of the method and system of the present disclosure require the use of a computing system associated with a three-dimensional camera system. Thus, with reference to FIG. 2, an exemplary system within computing environment 50 for implementing the disclosure includes a general purpose computing device in the form of computing system 52, commercially available from, for example, Intel, IBM, AMD, Apple, Motorola, Cyrix, etc. Components of computing system 54 may include, but are not limited to, processing unit 56, system memory 58, and system bus 60 that couples various system components including system memory 58 to processing unit 56. System bus 60 may be any of several types of bus structures including a memory bus or memory controller, a peripheral bus, or a local bus using any of a variety of bus architectures.

Computing system 52 typically includes a variety of computer readable media. Computer readable media can be any available media that can be accessed by computing system 52 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 52.

System memory 58 includes computer storage media in the form of volatile and/or nonvolatile memory such as read only memory (ROM) 62 and random access memory (RAM) 64. A basic input/output system (BIOS) 66, containing the basic routines that help to transfer information between elements within computing system 52, such as during start-up, is typically stored in ROM 62. RAM 64 typically contains data and/or program modules that are immediately accessible to and/or presently being operated on by processing unit 56. By way of example, and not limitation, operating system 68, application programs 70, other program modules 72, and program data 74 are shown.

Computing system 52 may also include other removable/non-removable, volatile/nonvolatile computer storage media. By way of example only, hard disk drive 76 that reads from or writes to non-removable, nonvolatile magnetic media, a magnetic disk drive 78 that reads from or writes to removable, nonvolatile magnetic disk 80, and an optical disk drive 82 that reads from or writes to removable, nonvolatile optical disk 84 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 76 is typically connected to the system bus 60 through a non-removable memory interface such as interface 86, and magnetic disk drive 78 and optical disk drive 82 are typically connected to the system bus 60 by a removable memory interface, such as interface 88.

The drives and their associated computer storage media, discussed above, provide storage of computer readable instructions, data structures, program modules and other data for computing system 52. For example, hard disk drive 76 is illustrated as storing operating system 90, application programs 92, other program modules 94 and program data 96. Note that these components can either be the same as or different from operating system 68, application programs 70, other program modules 72, and program data 74. Operating system 90, application programs 92, other program modules 94, and program data 96 are given different numbers here to illustrate that, at a minimum, they are different copies.

A participant may enter commands and information into the computing system 52 through input devices such as tablet or electronic digitizer 98, microphone 100, keyboard 102, and pointing device 104, commonly referred to as a mouse, trackball, or touch pad. These and other input devices are often connected to the processing unit 56 through a participant input interface 106 that is coupled to the system bus 60, but may be connected by other interface and bus structures, such as a parallel port, game port or a universal serial bus (USB).

Monitor 108 or other type of display device is also connected to the system bus 60 via an interface, such as a video interface 110. Monitor 108 may also be integrated with a touch-screen panel 112 or the like. Note that the monitor and/or touch screen panel can be physically coupled to a housing in which computing system 52 is incorporated, such as, for example, in a tablet-type personal computer or smart phone. In addition, computers such as computing system 52 may also include other peripheral output devices such as speakers 114 and printer 116, which may be connected through an output peripheral interface 118 or the like.

Computing system 52 may operate in a networked environment using logical connections to one or more remote computers, such as a remote computing system 120. The remote computing system 120 may be a personal computer (including, but not limited to, mobile electronic devices), a server, a router, a network PC, a peer device or other common network node, and typically includes many or all of the elements described above relative to computing system 52, although only a memory storage device 122 has been illustrated. The logical connections depicted include a local area network (LAN) 124 connecting through network interface 126 and a wide area network (WAN) 128 connecting via modem 130, but may also include other networks such as, for example, mobile telephone service networks. Such networking environments are commonplace in offices, enterprise-wide computer networks, intranets, mobile networks, and the Internet.

For example, in the present embodiment, computer system 52 may comprise the source machine from which data is being generated/transmitted and the remote computing system 120 may comprise the destination machine. Note however that source and destination machines need not be connected by a network or any other means, but instead, data may be transferred via any media capable of being written by the source platform and read by the destination platform or platforms.

In another example, in the present embodiment, remote computing system 120 may comprise the source machine from which data is being generated/transmitted and computer system 52 may comprise the destination machine.

In a further embodiment, in the present disclosure, computing system 52 may comprise both a source machine from which data is being generated/transmitted and a destination machine and remote computing system 120 may also comprise both a source machine from which data is being generated/transmitted and a destination machine.

Referring to FIG. 2, for the purposes of this disclosure, it will be appreciated that remote computer 120 may include any suitable term such as, but not limited to “device”, “processor based mobile device”, “mobile device”, “electronic device”, “processor based mobile electronic device”, “mobile electronic device”, “wireless electronic device”, or “location-capable wireless device,” including a smart phone or tablet computer.

The central processor operating pursuant to operating system software such as, but not limited to, Apple IOS®, Google Android® IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

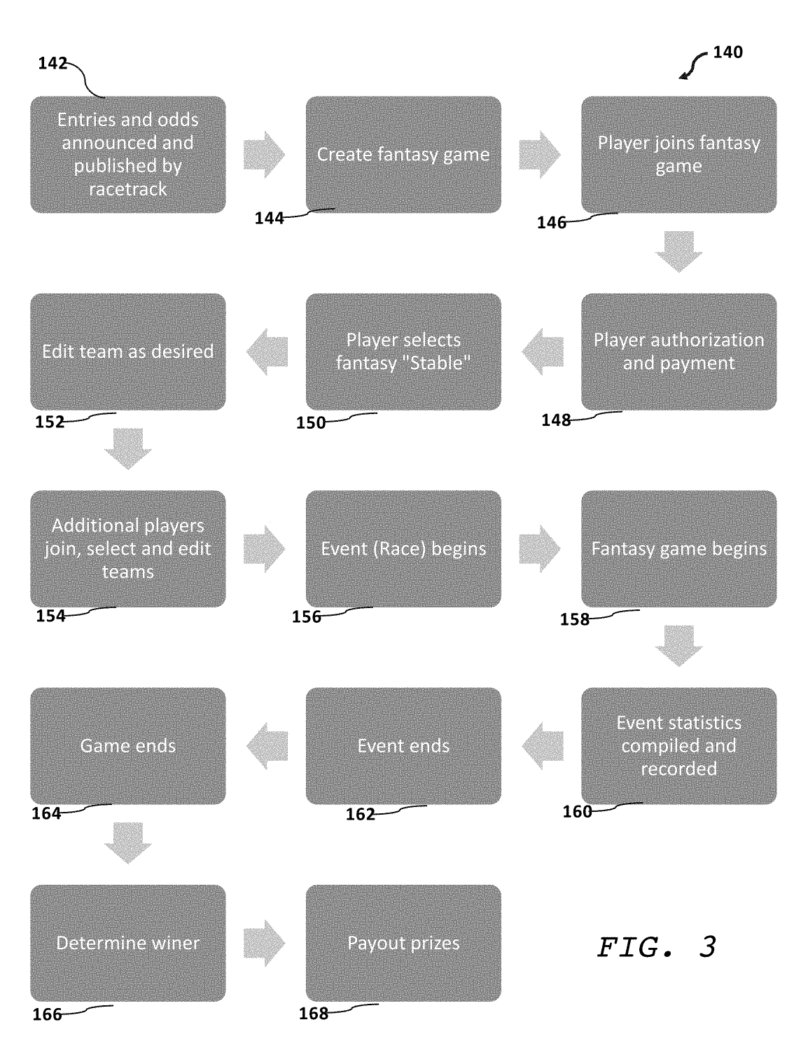

FIG. 3 depicts process flow 140 from a participant's perspective according to one embodiment of the disclosed subject matter. In process flow 140, step 142 represents the action of a racetrack publishing entries and odds to provide corresponding data associated with a daily event 12. In addition, at step 142, process flow includes the actions of acquiring race entries and odds from third party supplier. One such supplier may be Equibase Company LLC; however other such suppliers may provide similar data and information for announcing the entries and odds for a particular event 12.

Fantasy-style horse racing game 10 of the present disclosure converts odds that a given horse receives into salaries for use by participants. Thus, a participant receives from the present method and system, salary values respecting the horsed to be raced in a given contest. Generally, the participant does not see odds for a horse, but only the horse salary. However, another embodiment of the present disclosure may show horse odds without departing from the scope of the inventive subject matter.

At step 144, process flow 140 creates a fantasy horse-racing game. This may include establishing a prize pool, entry fees, horse racing track, the racing date, and other information. A participant may join horse racing game 10, at step 146. Here, the participant receives information about the event from race entry database 18 and, basically, begins interacting with fantasy-styled horse racing game.

Whether a participant has or needs to establish an account is determined, at step 148. A participant may also pay an entry fee, at step 148.

Step 150 permits the participant to select a “stable” of horses, as well as provides an automatic calculation of salary cap balance. Each contest within the disclosed subject matter is a “game” that requires the participant to select a “stable” of a certain number of horses (for a standard “StableDuel” game the number is ten horses). In selecting the horses for a stable, the participant must stay under the “salary cap” limit established for that game. For the present illustrative embodiment of fantasy-styled horse racing game 10, a salary cap could be $50,000. Horses are typically selected from the race card from a single track on a certain day. However, there may be contests that allow the participant to select horses from multiple tracks on a certain day, as well as selecting horses on a specified track over multiple days. For example, in the Breeder's Cup Championship, races occur over a two-day weekend. Such variations clearly fall within the scope of the present inventive subject matter. The salary for each horse will be determined by their morning line odds as may be provided by a track handicapper and published with the track entries.

The participant is not required to select a horse from each race on the card. The participant may select multiple horses from a certain race while selecting none from another. The participant, however, must select the required number of horses to complete their stable.

A participant may edit a stable, as desired, at step 152. Moreover, additional participants may join, select and edit teams, at step 154. At this point, horse racing game 10 closes contest entries at an established time, such as prior to post of first race and lists all for the contest on the horse racing game 10 website associated with game host 16.

The first horse race associated with fantasy-styled horse racing game 10 begins at step 156, followed immediately thereafter by the beginning of horse racing game at step 158. Fantasy-styled horse racing game 10 incorporates Equibase race event statistics representing results from each race at step 160.

At step 160, all other core operations of fantasy-styled horse racing game 10 also occur. So, after the first race occurs, system 10 receives statistics from Equibase all information concerning the actual horse race at the racetrack. This includes the first, second, etc. placing of the horses at finish, as well as the position of the horses in comparison to one another, etc. the numbers of lengths behind the winning horse.

Fantasy-styled horse racing game 10, in response to receiving race statistics, derives point values for each racing horse, as well as point values for each stable competing in the fantasy-styled horse race.

At step 162, the associated horse race event ends, followed by fantasy-styled horse racing game 10 ending at step 164. At step 166, all of the totals compiled throughout the day are totaled to derive a total score. Also at step 166, contest winners based upon final scoring occurs. Then, at step 168 of process flow 140, fantasy-styled horse racing game 10 pays prizes based upon the award schedule previously established at step 144.

To illustrate how the presently disclosed subject matter awards points, FIG. 4 presents point allocation chart 170 for graphically describing how game scoring may occur. Thus, FIG. 4 shows along the ordinate axis the relative finishing position of the horses in an actual race associated with fantasy-styled horse racing game 10. Along the abscissa axis appear points ranging from 0 to 70 points. So, a first place finishing position awards a horse 60 points, a second place finishing position awards 40 points, third place wins 30 points, fourth 20 points, and fifth 10 points. Sixth place and higher win no points.

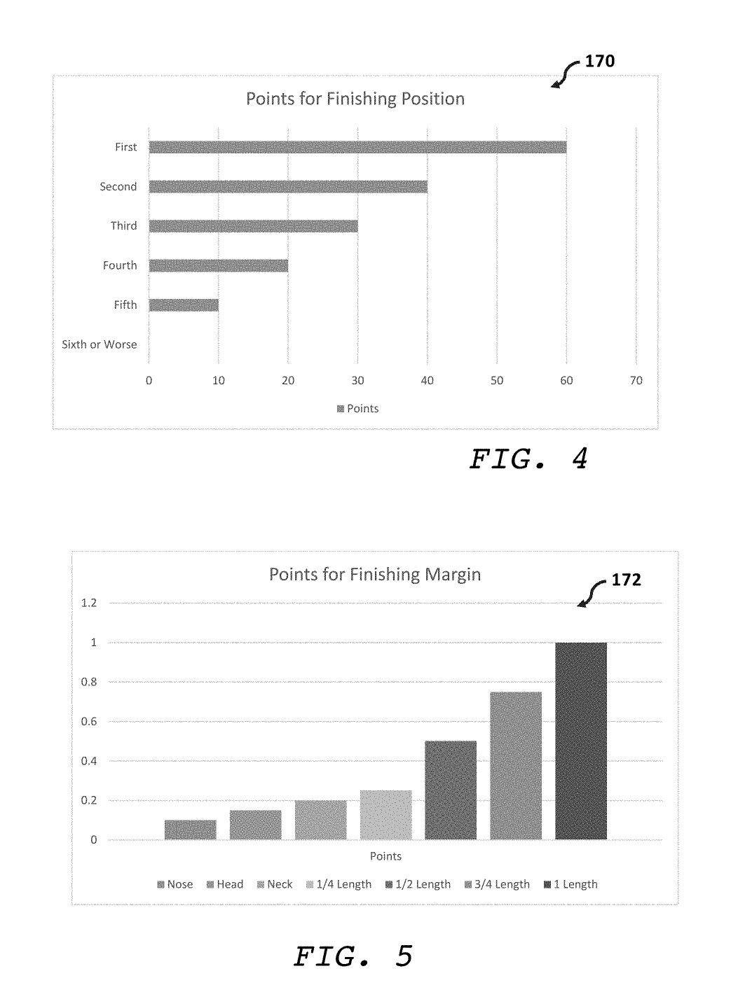

FIG. 5 separately shows chart 172 for illustrating how the present disclosure adjusts scores derived from the finishing position values according. Points will be calculated based on two determining factors; finishing position and margin of victory/defeat. Horses will earn points for their finishing position (first, second, third etc.), as FIG. 4 shows and then will have points added or subtracted from their total based on their margin of victory/defeat. As will be shown below, if the first place horse wins by 2½ lengths, for example, 2.5 points are added to his score of 60 points, for a total of 62.5 points. Conversely, if the third place horse lags the winner by 4¼ lengths, 4.25 points are subtracted from the 30 points earned for the third place finish, to yield a 25.75 point award.

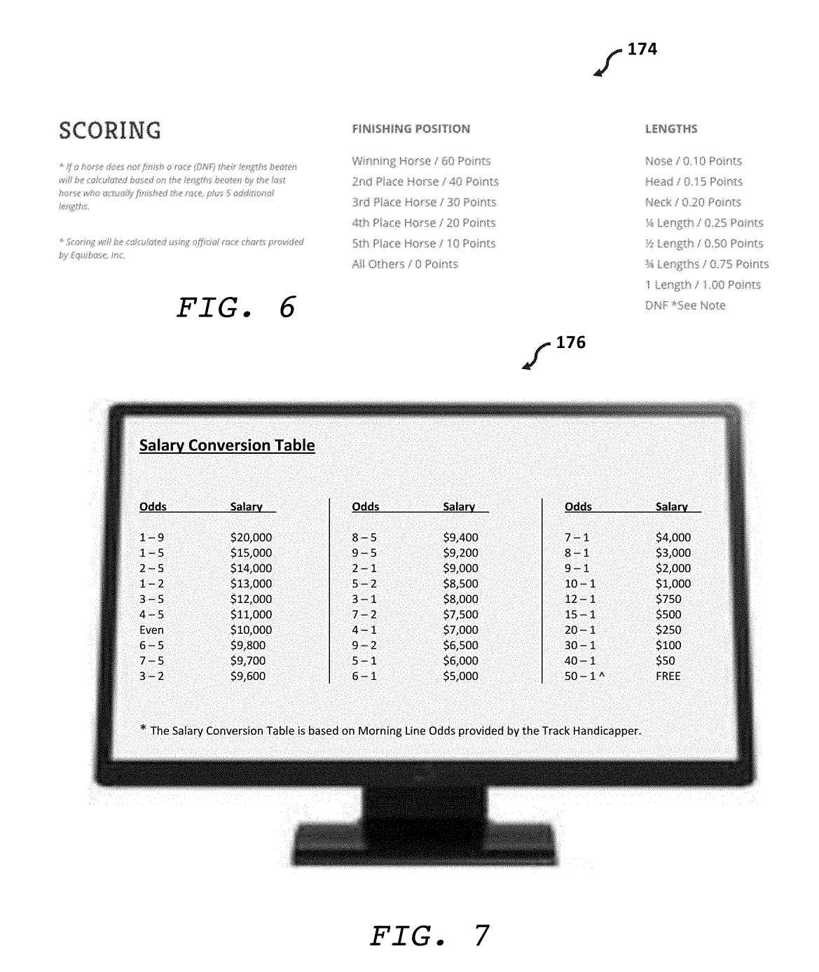

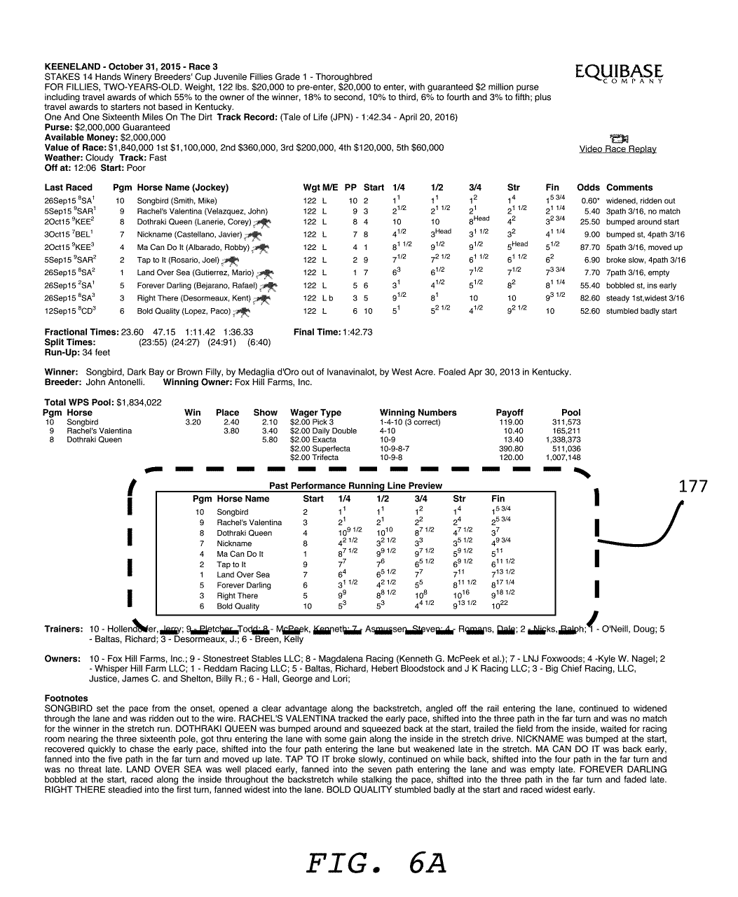

FIG. 6 summarizes the scoring brackets of FIGS. 4 and 5. Thus, the points added for finishing position and added or subtracted for length provide a basis for determining final scores for all horses recorded through fantasy-styled horse racing game 10.

FIG. 6A shows an exemplary data sheet, as may be provided by Equibase Company LLC. Through its website, upgraded mobile platform and mobile applications, Equibase Company LLC offers a comprehensive menu of handicapping products, statistical information and video race replays in support of the North American Thoroughbred racing industry. The company provides statistical profile pages for horses, jockeys, trainers, and owners, as well as Excellence Indicators to provide information on the person or horse's highest achievements.

In illustrating the exemplary races, the present disclosure uses Equibase Charts. The Equibase Charts help illustrate what the presently disclosed fantasy-style horse racing game uses to help with the scoring calculations. In particular, the following description references the “Past Performance Running Line Preview” data of the Equibase Charts to obtain finishing positions and margins of victory and/or defeat for each horse. That is, in the following charts appear the Past Performance Running Line Preview data, appearing in the far right column, to more specifically depict how one may play the disclosed fantasy-styled horse racing game 10.

For the FIG. 6A example of the Equibase Chart for a given thoroughbred horse race, the respective Past Performance Running Line Review data, i.e., segment 177 appears as follows:

Past Performance Running Line Preview

| Pgm | Horse Name | Start | ¼ | ½ | ¾ | Str | Fin |
|---|---|---|---|---|---|---|---|
| 10 | Songbird | 2 | 1¹ | 1¹ | 1² | 1⁴ | 1^{53/4} |
| 9 | Rachel's Valentina | 3 | 2¹ | 2¹ | 2² | 2⁴ | 2^{53/4} |
| 8 | Dothraki Queen | 4 | 10^{91/2} | 10¹⁰ | 8^{71/2} | 4^{71/2} | 3⁷ |
| 7 | Nickname | 8 | 4^{21/2} | 3^{21/2} | 3³ | 3^{51/2} | 4^{93/4} |
| 4 | Ma Can Do It | 1 | 8^{71/2} | 9^{91/2} | 9^{71/2} | 5^{91/2} | 5¹¹ |
| 2 | Tap to It | 9 | 7⁷ | 7⁶ | 6^{51/2} | 6^{91/2} | 6^{111/2} |
| 1 | Land Over Sea | 7 | 6⁴ | 6^{51/2} | 7⁷ | 7¹¹ | 7^{131/2} |
| 5 | Forever Darling | 6 | 3^{11/2} | 4^{21/2} | 5⁵ | 8^{111/2} | 8^{171/4} |
| 3 | Right There | 5 | 9⁹ | 8^{81/2} | 10⁸ | 10¹⁶ | 9^{181/2} |
| 6 | Bold Quality | 10 | 5³ | 5³ | 4^{41/2} | 9^{131/2} | 10²² |

In the FIG. 6A example, the race horse, Songbird, shows Fin (Finishing) position of 1, or 1^{st} place with a winning margin of 5 3/4 lengths. In the “Fin” (finish) column, this appears with the number 1 and superscript 5 3/4 . Thus, Songbird receives 60 points for winning and 5.75 points for winning by 5 3/4 lengths.

FIG. 7 presents salary conversion table 176 for converting odds of horses to salaries for a given race. Another important aspect of fantasy-styled horse racing game 10 includes associating horse salaries with odds. The odds may be obtained from the morning line odds that a racetrack may publish or distribute on race day. The morning line odds may, for example, be supplied by an official track handicapper. These are based on many factors and do not technically reflect how actual betting will progress. With reference to FIG. 7, salary conversion table 176 relates an individual horse's odds to a particular horse salary. Odds of 1-9 receive a salary of $20,000, 1-5 a salary of $15,000, 2-5 a $14,000 salary, etc.

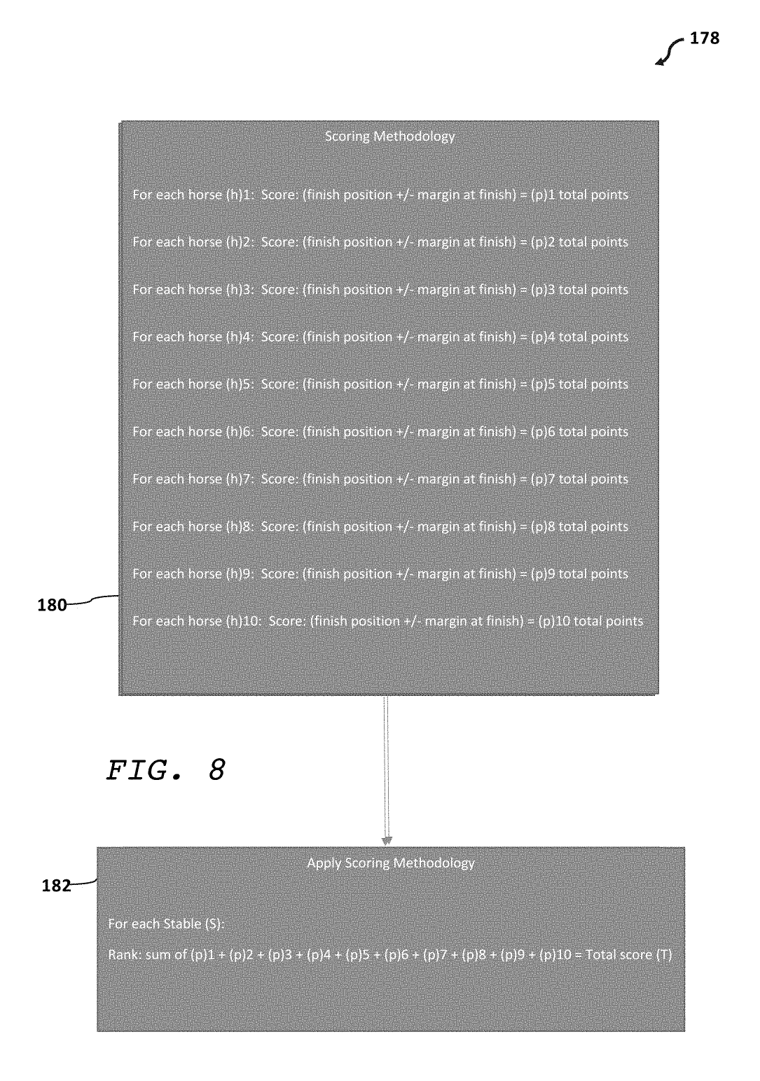

FIG. 8 depicts and illustrates potential application of a scoring methodology 178 consistent with the teachings of the present disclosure. In scoring methodology 178, point calculation step 180 derives total points for each horse a participant selects to race in fantasy-styled horse racing game 10. In the present example, ten horses comprise a stable that competes in nine races. Thus, for each horse, the score of (a) finishing position value [ranging from 0 to 60] and (b) margin at finish are calculated for a given horse total point score (h)1 through (h)10. The value for the margin at finish ranges from 0 to the number of lengths and portions of lengths ( 1/4 , 1/2 , 3/4 ) by which the winning horse leads the other racing horses. At step 182, scoring methodology 178 calculates a rank as a sum of the individual horse values (h)1 through (h)10 to achieve a final sum total score (T).

As an example of the game, consider that when a participant plays fantasy-styled horse racing game 10, his stable comprises ten horses, i.e., one stable per participant and, here, ten horses in the one stable. With nine races in an event, fantasy-styled horse racing game 10 calculates ten final sum total scores; one for each of the ten racing horses in the participant's stable.

In understanding the scoring methodology of FIG. 8, consider the example of an event having nine races. For every race, the present method and system receive from Equibase all of the statistics of the race. Fantasy-styled horse racing game 10 processes the received information and performs the calculations, as shown in FIG. 8. The system and method derive this information for each horse. Such as, for example, if a horse won a race by five lengths, the horse receives 60 points for winning the race and 5 more points for winning by five lengths, for a total of 65 points. Fantasy-styled horse racing game 10 performs these operations internally, so that the participant receives only the results that the game calculates.

In addition to performing the scoring methodology of FIG. 8, however, fantasy-styled horse racing game 10 further compiles a leader board that shows how each of the participating stables have fared against each other.

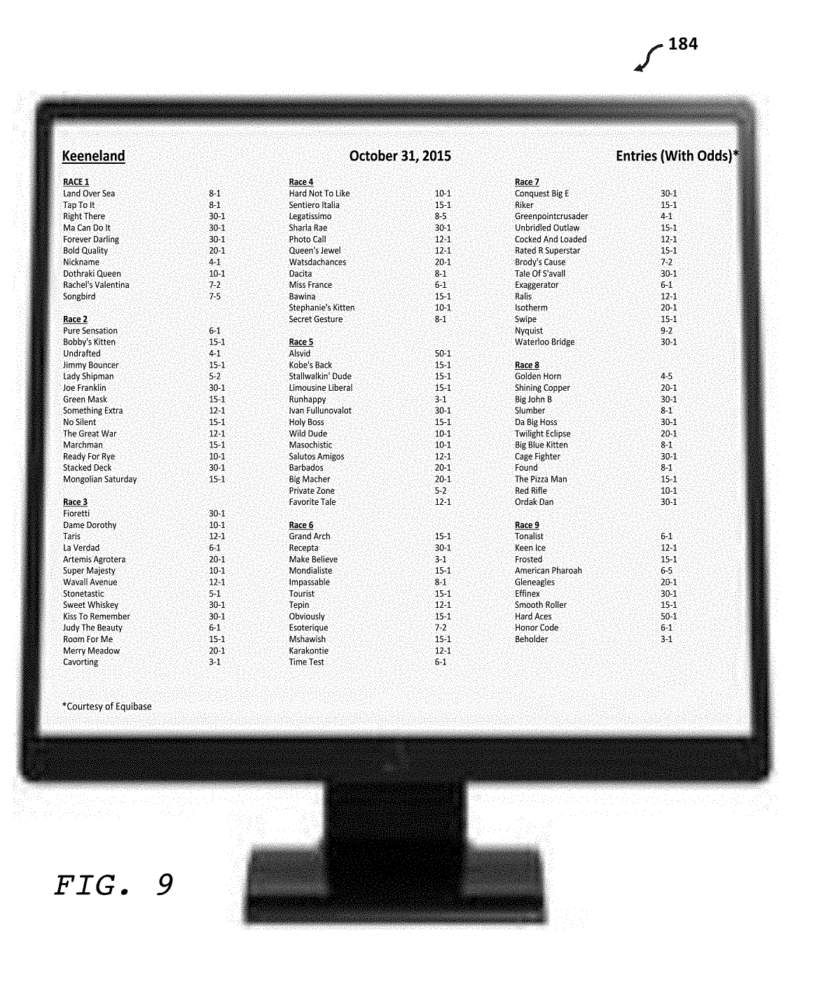

FIG. 9 shows odds for horses scheduled to run on a particular race day for showing an illustrative embodiment of the present disclosure. For example, the example of Keeneland Thoroughbred race track here provides the entries for a given event. FIG. 10, then, shows the results of converting the odds of FIG. 9 to salaries according to the rules appearing in FIG. 7, above. Moreover, FIG. 10 associates salaries with each horse in race 1 190 through race 9 206. These race salary determinations determine values associated with stable formation as demonstrated at FIGS. 11 through 20, below.

FIGS. 11 through 20 present an exemplary stable selection process incorporating the processes, odds, and salaries of FIGS. 7 through 10. Beginning with FIG. 11, the stable selection process starts with a blank stable template 188. In blank stable template 188, the participant receives a salary remaining value of $50,000. It is from this salary resource that the participant may assign horses to the stable. Once a race horse has been selected for a particular race, the salary for the particular horse deducts from the $50,000 total.

At FIG. 12 appears the stable information from the stable selection process after race 1 wherein stable template 190 shows entries for race 1, as depicted originally in FIG. 10. For race 1, FIG. 12 demonstrates the horse, Songbird, with a salary of $9,700 is selected and then goes to a stable position. The participant then has the $9,700 amount deducted from his salary remaining sum, leaving a $40,300 salary remaining.

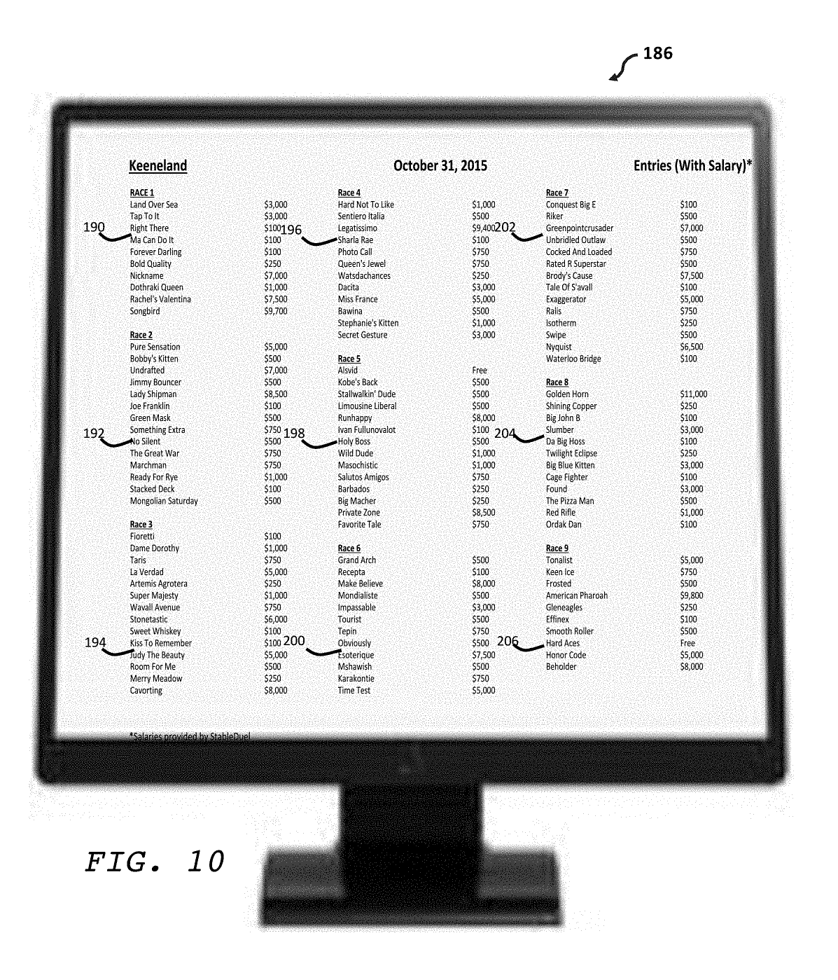

At FIG. 13 appears the stable information from the stable selection process after race 2 wherein stable template 192 shows entries for race 2, as depicted originally in FIG. 10. Thus, for race 2, FIG. 13 demonstrates that no selection was made to keep the $40,300 salary remaining.

At FIG. 14 appears the stable information from the stable selection process after race 3 wherein stable template 194 shows entries for race 3, as depicted originally in FIG. 10. Thus, for race 3, FIG. 14 demonstrates the horse, Cavorting, with a salary of $8,000 is selected and then goes to a stable position. The participant then has the $8,000 amount deducted from his salary remaining sum, leaving a $32,300 salary remaining.

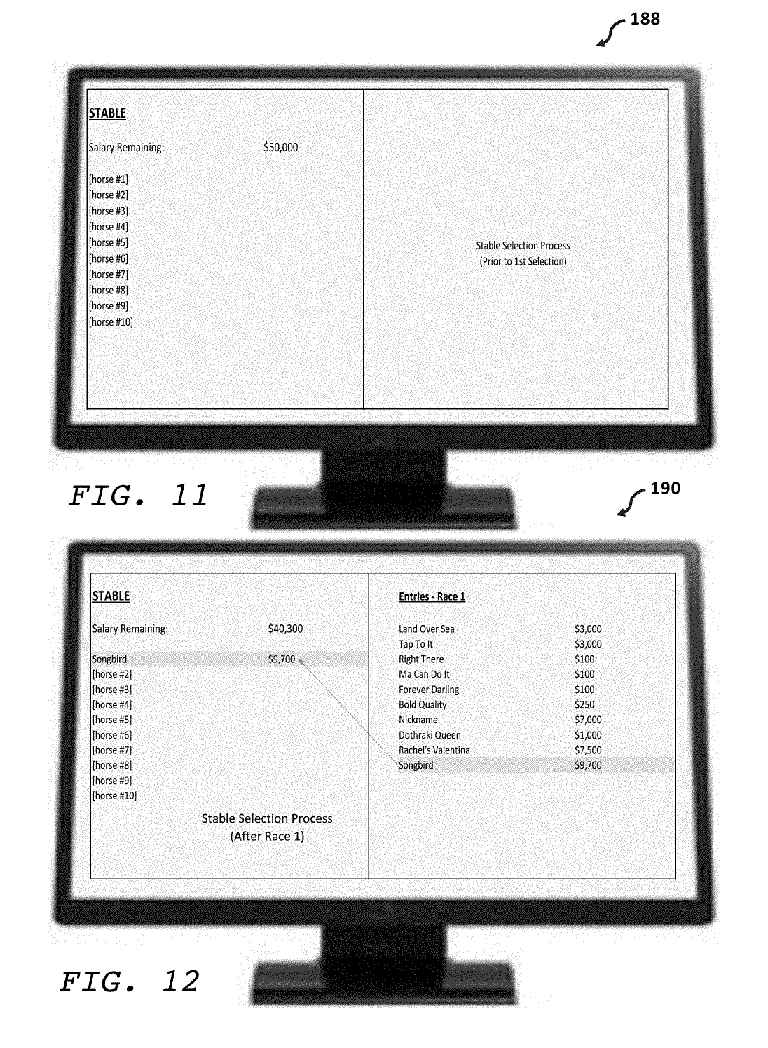

At FIG. 15 appears the stable information from the stable selection process after race 4 wherein stable template 196 shows entries for race 4, as depicted originally in FIG. 10. Thus, for race 4, FIG. 15 demonstrates the horses, Legatissimo at $9,400 and Dacita at $3,000 are selected for stable positions. The participant then has the $12,400 amount deducted from his salary remaining sum, leaving a $19,900 salary remaining.

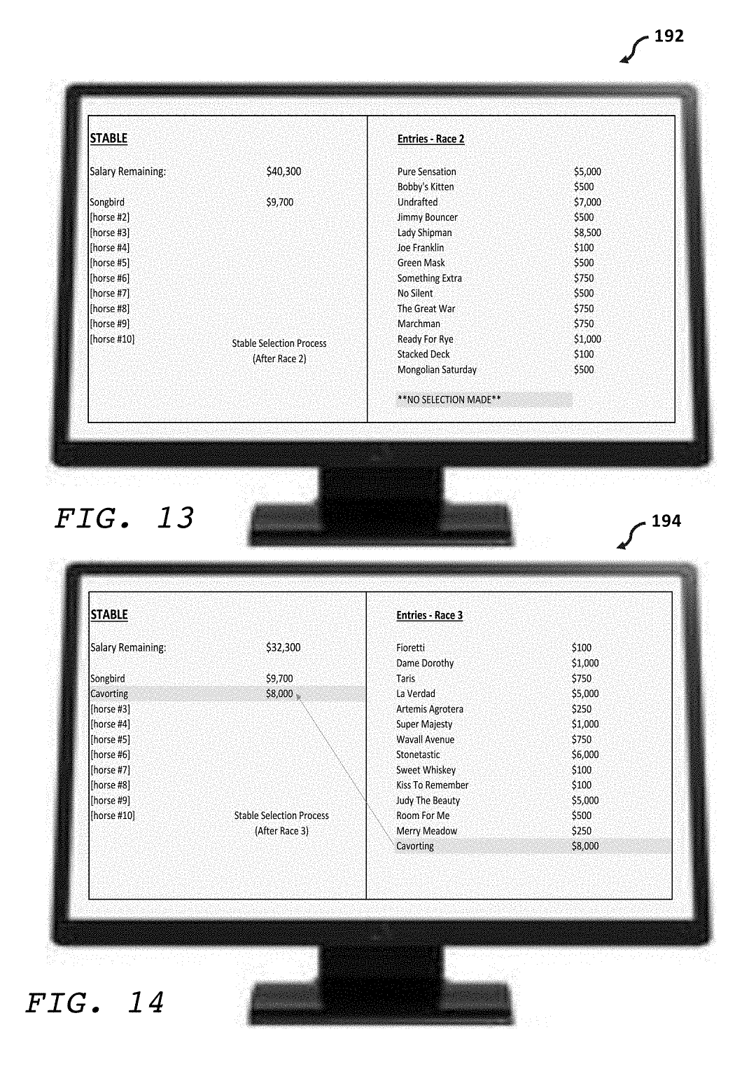

At FIG. 16 appears the stable information from the stable selection process after race 5 wherein stable template 198 shows entries for race 5, as depicted originally in FIG. 10. Thus, for race 5, FIG. 16 demonstrates the horse; Kobe's back, with a salary of $500 is selected and then goes to a stable position. The participant then has the $500 amount deducted from his salary remaining sum, leaving a $19,400 salary remaining.

At FIG. 17 appears the stable information from the stable selection process after race 6 wherein stable template 200 shows entries for race 6, as depicted originally in FIG. 10. Thus, for race 6, FIG. 17 demonstrates the horses, Grand Arch at $500 and Tepin at $750 are selected for stable positions. The participant then has the $1,250 amount deducted from his salary remaining sum, leaving a $18,150 salary remaining.

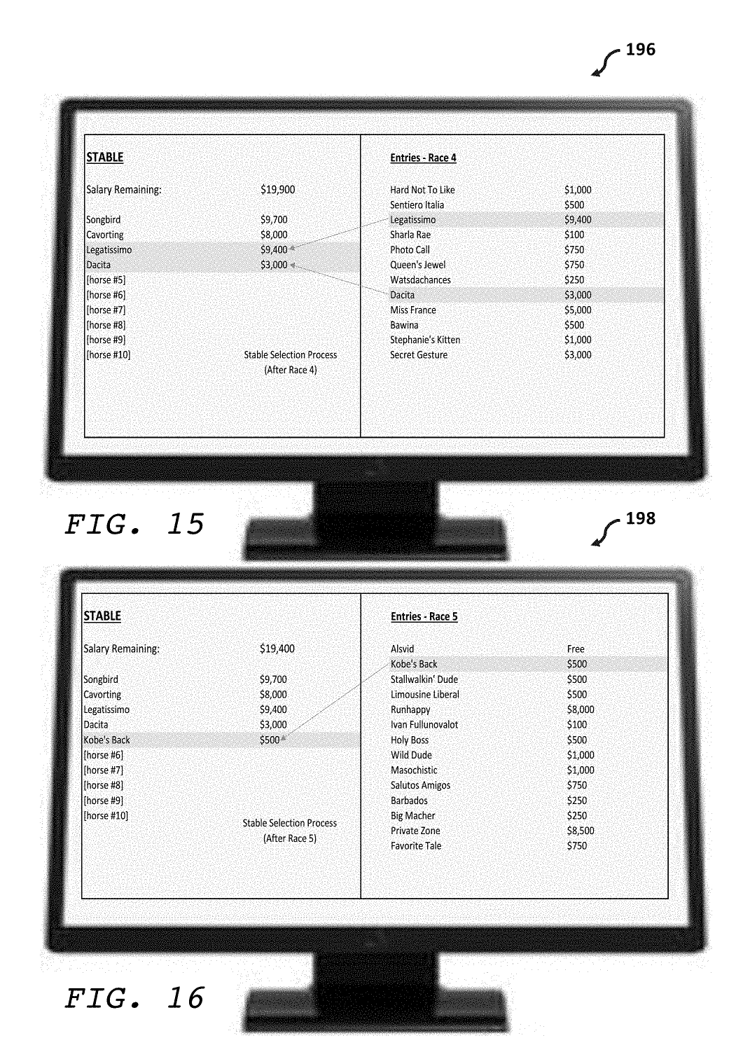

At FIG. 18 appears the stable information from the stable selection process after race 7 wherein stable template 202 shows entries for race 7, as depicted originally in FIG. 10. Thus, for race 7, FIG. 18 demonstrates the horse, Greenpointcrusader, with a salary of $7,000 is selected and then goes to a stable position. The participant then has the $7,000 amount deducted from his salary remaining sum, leaving an $11,150 salary remaining.

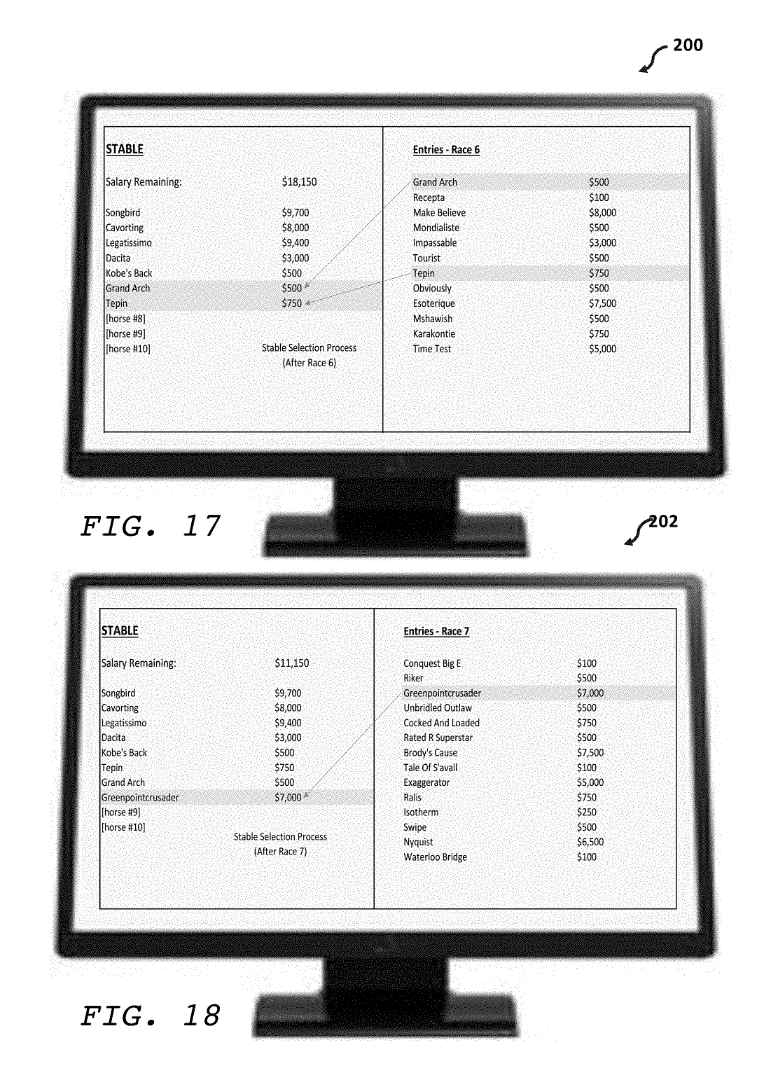

At FIG. 19 appears the stable information from the stable selection process after race 8 wherein stable template 204 shows entries for race 8, as depicted originally in FIG. 10. Thus, for race 8, FIG. 19 demonstrates the horse, The Pizza Man, with a salary of $500 is selected and then goes to a stable position. The participant then has the $500 amount deducted from his salary remaining sum, leaving a $10,650 salary remaining.

At FIG. 20 appears the stable information from the stable selection process after race 9 wherein stable template 206 shows entries for race 9, as depicted originally in FIG. 10. Thus, for race 9, FIG. 20 demonstrates the horse, American Pharoah, with a salary of $9,800 is selected and then goes to a stable position. The participant then has the $9,800 amount deducted from his salary remaining sum, leaving an $850 salary remaining.

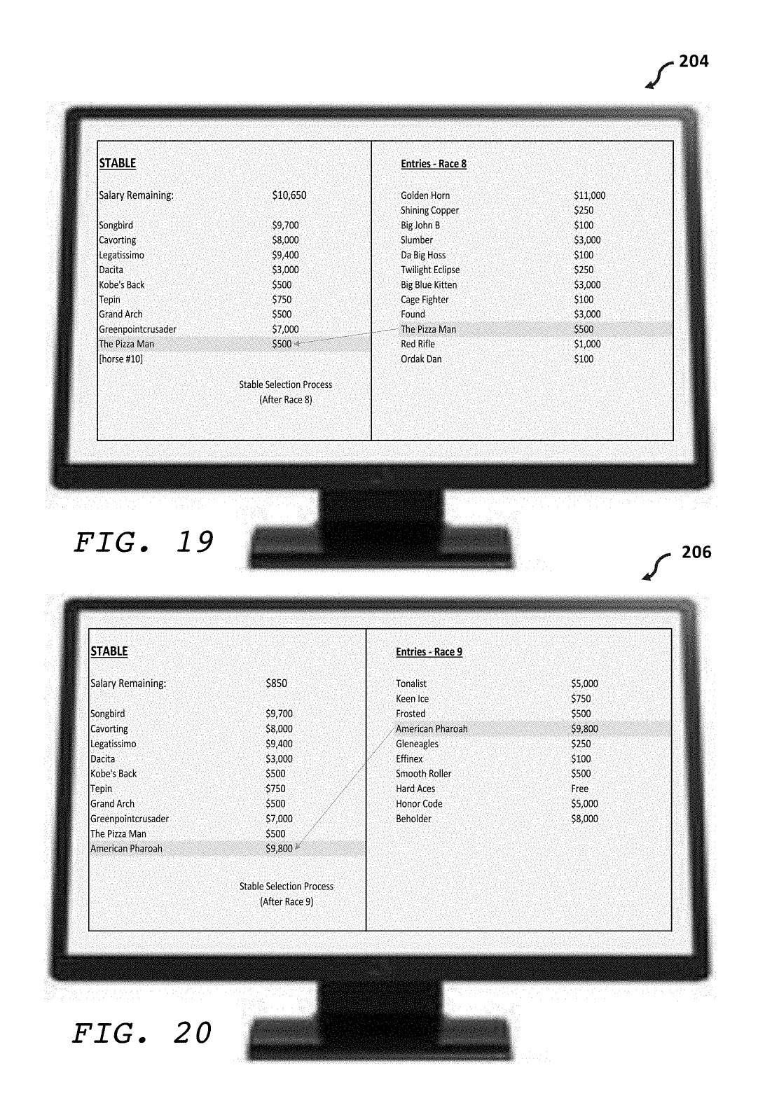

FIGS. 21 through 30 depict an exemplary application of the present disclosure to illustrate how fantasy-style horse racing game 10 compiles scores. Thus, once a participant selects a stable, as FIGS. 11 through 20 show, for example, scoring occurs during an event. The illustrative example of FIGS. 21 through 30 show how scoring include points for finishing positions and relative position at the conclusion of each race of the event. So, using charts from Equibase, fantasy-style horse racing game 10 extracts the information about the races and uses the extracted information for determining point scores for all horses participating in the event.

FIGS. 21 through 30 demonstrate how one may play the fantasy-styled horse racing game 10 of the present disclosure, using an example of the Breeders Cup championship that was held in 2015. The illustrative example of FIGS. 21 through 30 shows how a participant, “Augie Greiner,” may have selected a stable for a racing event and shows the progressive results of the selected stable throughout a racing event. FIG. 21 displays that no points have yet been awarded for a stable that includes Songbird (7-5 odds and $9,700 salary); Cavorting (3-1 odds and $8,000 salary); Legatissimo (8-5 odds and $9,400 salary); Dacita (8-1 odds and $3,000 salary); Kobe's Back (15-1 odds and $500 salary); Grand Arch (15-1 odds and $500 salary); Tepin (12-1 odds and $750 salary); Greenpointcrusader (4-1 odds and $7,000 salary); The Pizza Man (15-1 odds and $500 salary); and American Pharaoh (7-5 odds and $9,700 salary).

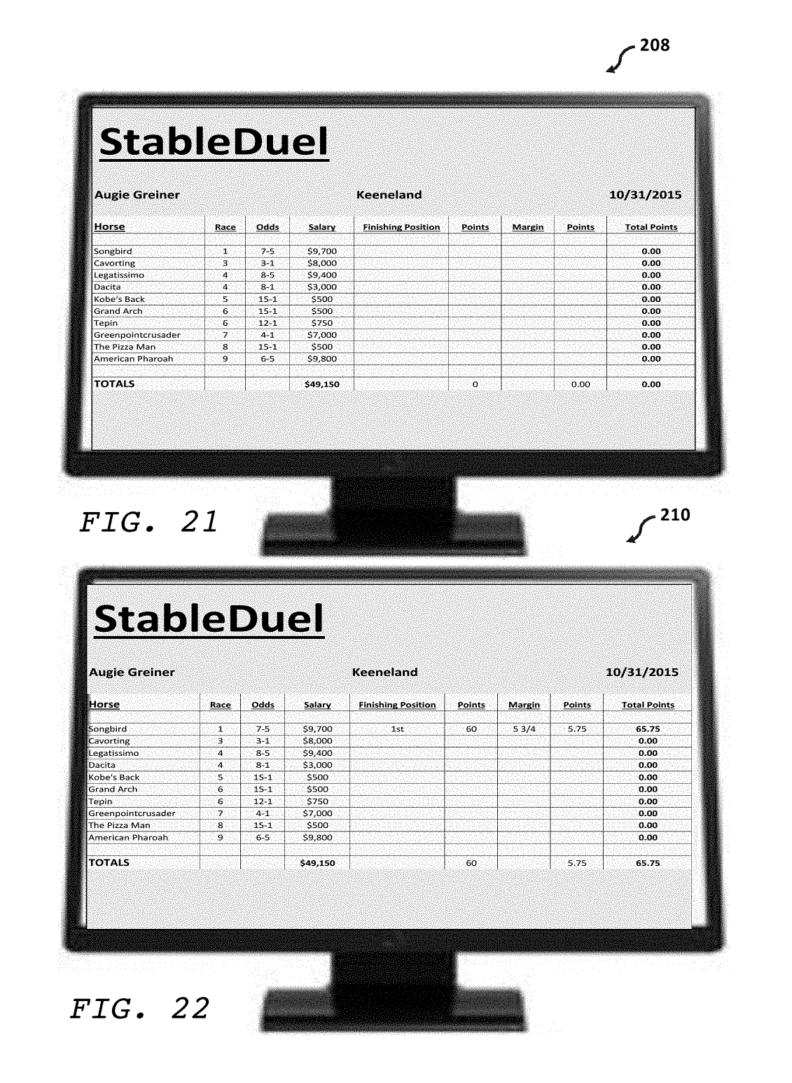

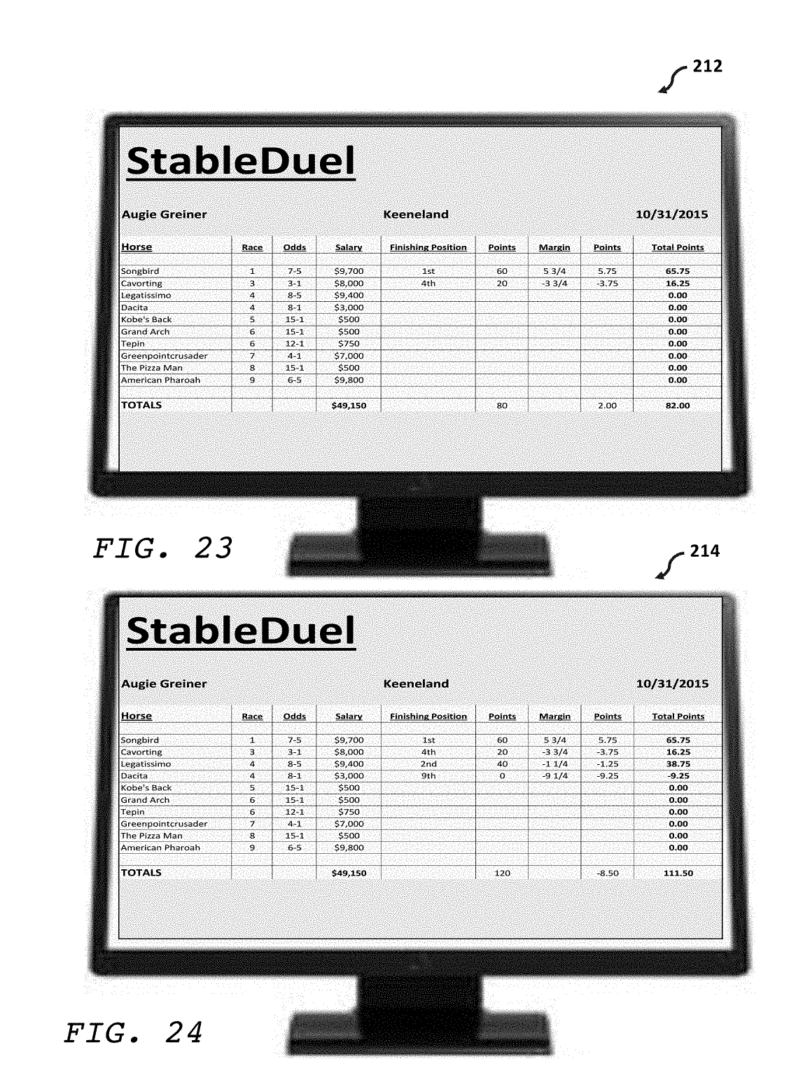

FIG. 22 then shows that Songbird has received 65.75 points upon finishing in 1st place in race 1 and winning by 5 3/4 lengths. Greiner's stable has no horse in race 2. FIG. 23 further shows that Cavorting placed 4th in race 3, and was 3 3/4 lengths behind the winner, causing a negative 3.75 points deducted from the 20 point 4th place value. This gives Cavorting a 16.25 point value. The total for participant Augie Greiner's stable then becomes 82 points.

FIG. 24, depicts the results of race 4, wherein the stable includes 2nd place horse trailing by 1 1/4 lengths, Legatissimo, and 9th place horse trailing by 9 1/4 lengths, Dacita. Here, Legatissimo receives 38.75 points (40 minus 1.25 points) and Dacita receives −9.25 points (0 minus 9.25 points). Note, that now the stable has a 111.50 point total.

FIG. 25 sets forth that, after race 5, Greiner's stable includes 7th placing horse Kobe's Back, at 4.5 lengths back. This gives a total of 0 points for the placing and minus 4.50 points for being 4.50 lengths behind. Now, the stable value has lost 4.50 points for a total of 107 points.

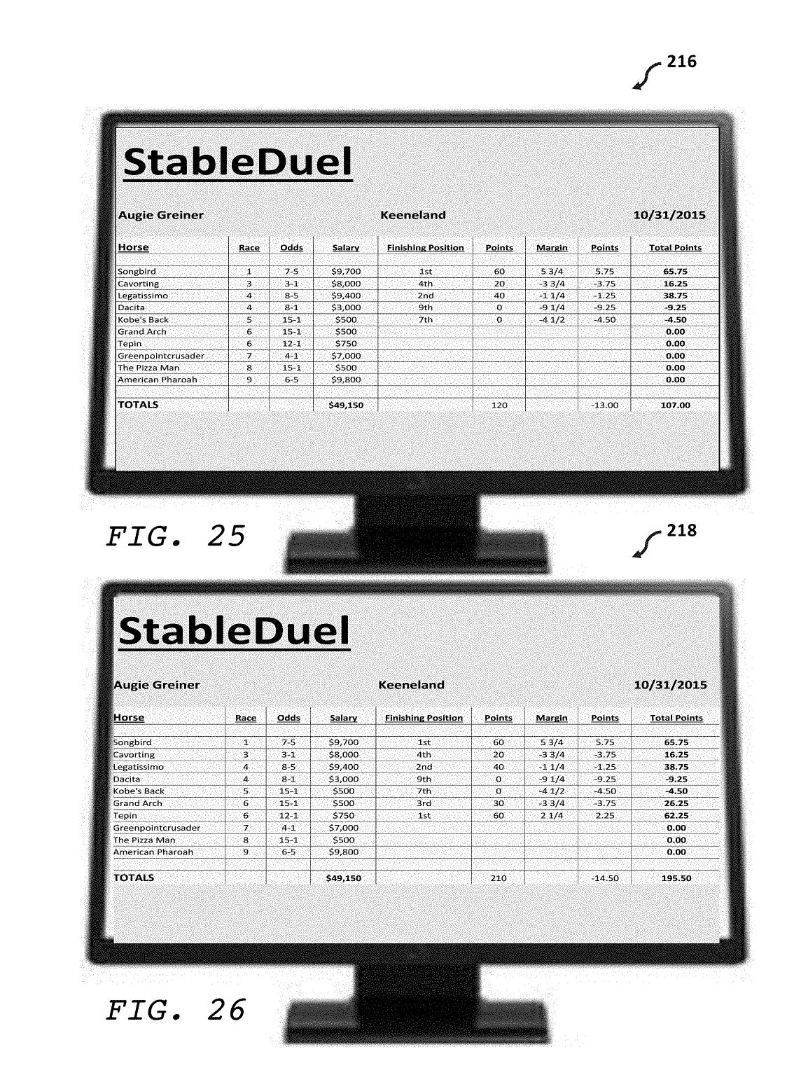

FIG. 26 shows the results after race 6, where Grand Arch places 3rd at 3 3/4 lengths behind, resulting in a point total of 26.25 (30 minus 3.75), and Tepin wins 1st place, at 2 1/4 lengths ahead for a score of 62.25 (60 plus 2.25) points. Now, Greiner's stable point totals 195.50.

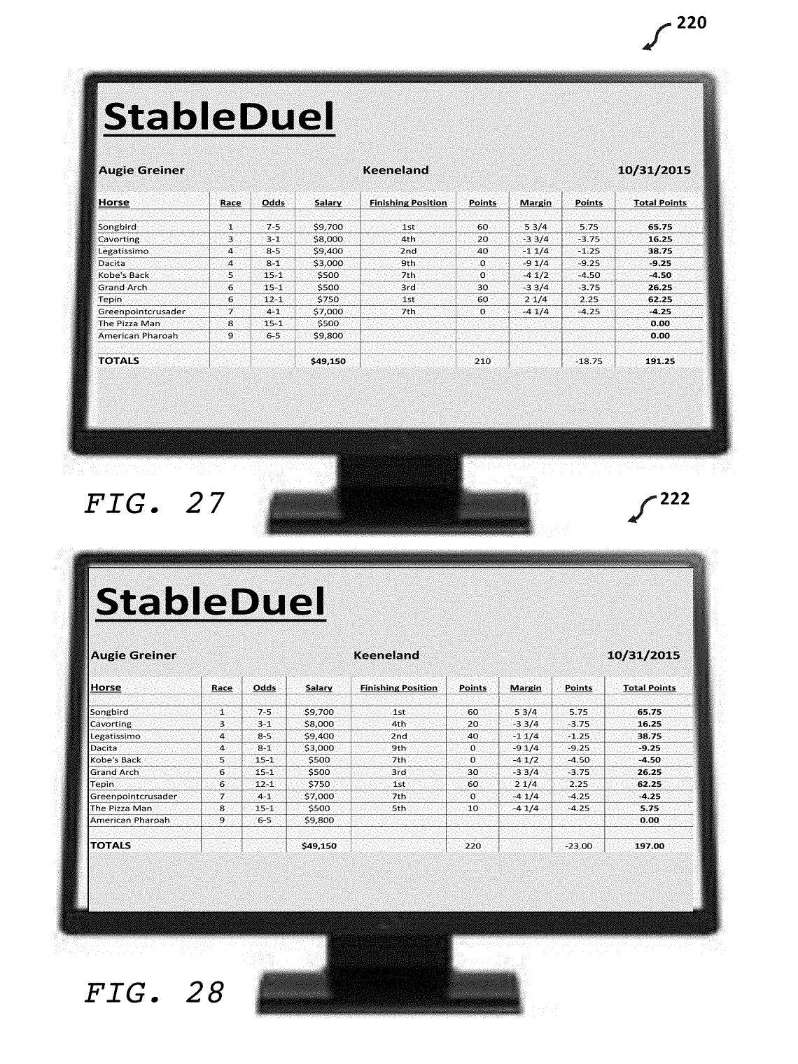

In race 7, Greenpointcrusader places 7^{th} at 4 1/4 lengths behind, resulting in 4.25 being subtracted from stable total, leaving a 191.25 total, as FIG. 27 shows. In race 8, The Pizza Man places 5^{th} to earn 10 points at 4.25 lengths behind for a total of 5.75 points. Here, FIG. 28, shows a total of 197 points.

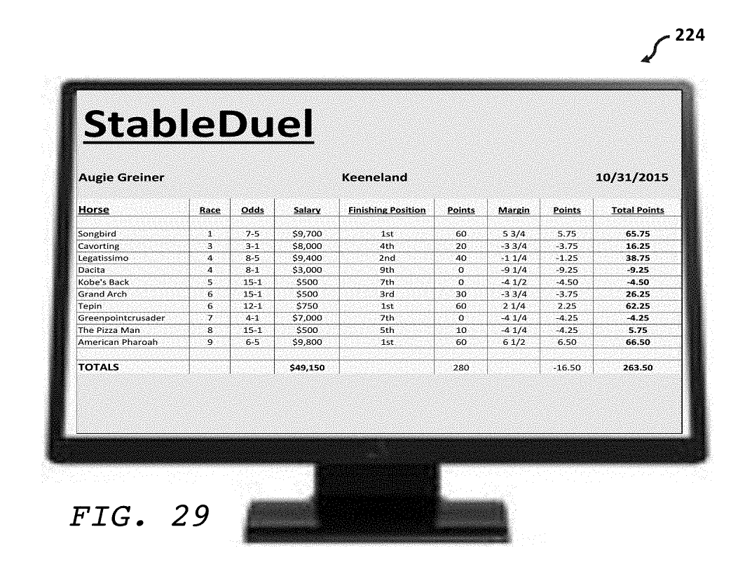

Finally, FIG. 29 shows that in race 9 American Pharaoh wins by 6 1/2 lengths. This totals 66.50 points adding to the stable total, for an event total of 263.50 points. For determining the winner of the day's event, Greiner's 263.50 stable total will be compared to that of other participants. The highest point total will win for the day.

The method and system of the present disclosure incorporate a number of rules according to the racing format and other aspects of the associated racing event. For example, in addition to the above exemplary illustrations of operating fantasy-style horse racing game 10, the present disclosure contemplates utilizing several “rules” specific to said game operation. The rules described in the following paragraphs are exemplary of those that will be utilized within the game operation. The game operation will not be limited to these rules, as others not listed here, may also be required.

“Multiple Horse Entries”. Periodically during a racing event (e.g., the actual horse race), the issue of an “Entry” will arise. An “Entry” occurs when an owner has more than one horse entered into a given race. In this instance, instead of each horse being a separate betting interest, the horses are coupled together to form ONE betting interest. Entries can include two, three, and sometimes four horses. For game purposes, scoring will be calculated based upon current pari-mutuel guidelines regarding this situation. These guidelines stipulate that the horse from the “Entry” that finishes in the best position will be the one used for scoring calculations. An example of a multiple horse entry situation includes a two (2) horse entry, with horses finishing 1st and 5th respectively. Here, scoring would be based on the 1st place finisher, not the 1st and 5th place finishes. All other horses in the race will not be affected by the position of the entry horses as far as finishing position and margin of defeat are concerned. Using the same example from above, if a horse finished 6th (one position behind the second horse in the entry) scoring would still be based on a 6th place finish and the margin of defeat would remain the same.

“Scratched Horses”. In the event of a scratch, i.e., a selected horse is removed from the actual race, the participant will be notified immediately and will be given the opportunity to make a replacement selection. The replacement selection does not need to come from the same race as the scratched horse, but it must come from either that race or a following race. The replacement selection must be made prior to the replacement horse running, not retroactively. The replacement selection must still allow the stable to remain under the salary cap limit established for that contest. If no replacement is selected for the scratched horse, the participant will be awarded a score of “0” points for that horse.

“Disqualifications”. In the event there is a disqualification, scoring will be recalculated based on the following guidelines. The disqualified horse will be scored based upon its subsequent finishing position as determined by the track stewards. For example: if a horse finishes 1st but is disqualified to 3rd, the horse will receive points for a 3rd place finish (30 points) and the margin of defeat will be equivalent to that of the horse it was placed behind. So, using the example from above, if the horse who “originally” finished 3rd was beaten by 5 lengths then the disqualified horse (who now is credited with a 3rd place finish) will also be determined to have been beaten by 5 lengths, and therefore would have 5 points deducted from its score.

Within the disclosed subject matter a variety of differing contests are available. For example, in addition to the standard “StableDuel” game which has been utilized for example purposes throughout this document, players may also select games that differ as to stable size (number of horses required to fill out a stable) and salary cap limits. Contests will also be available that consist of multiple tracks being utilized, as well as contests that span more than one day. Examples of these contests include, but are not limited to, the following:

A StableDuel Multi game would provide that the participant select a “Stable” of ten (10) horses and provides a “Salary Cap” of $50,000. Horses may be selected from the race card at multiple tracks on a certain day.

A MiniDuel game would provide that the participant select a “Stable” of five (5) horses and provides a “Salary Cap” of $25,000. Horses must be selected from the race card at a single track on a certain day.

A MiniDuel Multi game may provide that the participant select a “Stable” of five (5) horses and provides a “Salary Cap” of $25,000. Horses may be selected from the race cards at multiple tracks on a certain day.

A LongshotDuel game would provide that the participant to select a “Stable” of ten (10) horses and provides a “Salary Cap” of $10,000. Horses must be selected from the race card at a single track on a certain day.

A LongshotDuel Multi game would provide that the participant select a “Stable” of ten (10) horses and provides a “Salary Cap” of $10,000. Horses may be selected from the race cards at multiple tracks on a certain day.

A MegaDuel game would provide that the participant select a “Stable” of twenty five (25) horses and provides a “Salary Cap” of $100,000. Horses must be selected from the race card at a single track on a certain day.

Furthermore, the MegaDuel Multi game would provide that the participant select a “Stable” of twenty five (25) horses and provides a “Salary Cap” of $100,000. Horses may be selected from the race cards at multiple tracks on a certain day.

In addition to the various contests available, a variety of contest “types” also fall within the scope of the present disclosure. For instance, a Maiden contest would be for participants who have never won a game on StableDuel. These will be contests primarily made up of participants who are new to playing StableDuel or have a limited experience playing. These contests give the participant a much better chance to win as they do not allow the more experienced participants to compete.

An Allowance contest could be a step up from the “Maiden” ranks. These contests are for participants who meet certain conditions that restrict who may compete. An example may be a contest that is restricted to participants who, at best, have only won once in their lifetime. Or a contest for participants who have not won a contest in the past year. Or a contest for participants who have not won a certain amount of money playing StableDuel.

A Stakes contest could be a step up from the “Allowance” ranks. These contests are for participants who may no longer compete in the Maiden or Allowance contests. These contests usually consist of higher entry fees and larger prize pools. These contests are open to anyone; however, the competition will be much tougher.

A Grade III Stakes contest could be a step up from the “Stakes” ranks. These contests are also for participants who may no longer compete in the Maiden and Allowance contests. These contests will usually consist of higher entry fees and larger prize pools than even the Stakes contests. These contests are also open to everyone; however, the competition will be even tougher than the Stakes competition. These contests will mainly consist of the better handicappers.

A Grade II Stakes contest could be a step up from the Grade III Stakes ranks. These contests are also for participants who may no longer compete in the Maiden and Allowance contests. These contests will usually consist of higher entry fees and even larger prize pools than the Grade III contests. These contests are open to everyone; however, the competition gets even tougher. These contests will mainly consist of the better handicappers.

And, a Grade I Stakes contest could be the best of the best. These will be the top end of the contests. They will be open to everyone, however, they will usually consist of higher entry fees (some greater than $1,000) and will mainly consist of the best handicappers. These contests will usually offer the largest prize pools available, some even reaching $1,000,000 or more.

For the purposes of this disclosure, the terms “individual” and “participant” may be synonymous.

The embodiments described above are exemplary and are not to be taken as limiting in any way. They are merely illustrative of the principles of the disclosure. Various changes, modifications and alternatives will be apparent to one skilled in the art. Accordingly, it is intended that the art disclosed shall be limited only to the extent required by the appended claims and the rules and principles of applicable law.

1. A method for conducting a fantasy-style horse racing game applying pari-mutuel wagering, said racing scoring game specifying receiving a maximum stable value for an aggregated plurality of pre-race salary values and an nth horse selection, the method comprising:
receiving, via a network, pre-race odds for a plurality of horses across a plurality of races;
determining on a computer processor associated with said network, and for each of the plurality of horses, a pre-race salary value and a stable of horses for a racing event;
receiving on said computer processor associated with said network a rules selection for a given name, said rules selection specifying at least:
said maximum stable value for said aggregated plurality of pre-race salary values; and
said nth horse selection;
for a first participant, receiving a first participant first horse selection through a first participant nth horse selection;
for said nth participant, receiving an nth participant first horse selection through an nth participant nth horse selection;
receiving on said computer processor associated with said network race results via a network connection;
determining from said race results received on said computer processor associated with said network a score value for each of said plurality of horses across said plurality of races;
determining on said computer processor associated with said network, for said first participant, an aggregated score value for a first participant stable;
determining on said computer processor associated with said network, for said nth participant, an aggregated score value for an nth participant stable; and
determining on said computer processor associated with said network, a highest value stable selected from said first participant stable and said nth participant stable.

2. The method of claim 1, further comprising the step of awarding finishing position points according to a finishing position of the horses in a given race.

3. The method of claim 1, further comprising the step of adjusting scores derived from the finishing position points according to horse finishing margins.

4. The method of claim 1, further comprising the step of deriving horse salaries by converting odds of horses to salaries for a given race.

5. The method of claim 1, further comprising the step of scoring horse racing results according to finishing positions and finishing margins

6. The method of claim 1, further comprising the step of calculating stable point values for a participant stable upon the finishing of a each race in a racing event.

7. The method of claim 1, further comprising the step of conducting said fantasy-style horse racing scoring game applying said pari-mutuel wagering across multiple racing days.

8. A computerized system for conducting a fantasy-style horse racing scoring game applying pari-mutuel wagering, said racing scoring game specifying receiving a maximum stable value for an aggregated plurality of pre-race salary values and an nth horse selection, the system comprising:
instructions for receiving, via a network, pre-race odds for a plurality of horses across a plurality of races;
instructions for determining on a computer processor associated with said network, and for each of said plurality of horses, a pre-race salary value and a participant stable of horses for a racing event by applying said pari-mutuel wagering;
instructions for receiving on said computer processor associated with said network a rules selection for a given game, said rules selection specifying at least:
said maximum stable value for said aggregated plurality of pre-race salary values; and
said nth horse selection;
for said first participant, instructions for receiving a first participant first horse selection through a first participant nth horse selection;
for said nth participant, instructions for receiving an nth participant first horse selection through an nth participant nth horse selection;
instructions for receiving on said computer processor associated with said network race results via a network connection;
instructions for determining from said race results on said computer processor associated with said network, a score value for each of said plurality of horses across said plurality of races;
instructions for determining on said computer processor associated with said network, for said first participant, an aggregated score value for a first participant stable;
instructions for determining on said computer processor associated with said network, for said nth participant, an aggregated score value for an nth participant stable; and
instructions for determining on said computer processor associated with said network and highest value stable selected from said first participant stable and said nth participant stable.

9. The system of claim 8, further comprising instructions for awarding points according to the finishing position of horses in a given race.

10. The system of claim 8, further comprising instructions for adjusting scores derived from the finishing position points according to horse finishing margins

11. The system of claim 8, further comprising instructions for deriving horse salaries by converting odds of horses to salaries for a given race.

12. The system of claim 8, further comprising instructions for scoring horse racing results according to finishing position and finishing margins.

13. The system of claim 8, further comprising instructions for calculating stable point values for a participant stable upon the finishing liar each race in a racing event.

14. The system of claim 8, further comprising instructions for conducting said fantasy-style horse racing scoring game applying pari-mutuel wagering across multiple racing days.

15. A non-transitory computer readable medium comprising a system for conducting a fantasy-style horse racing scoring game applying pari-mutuel wagering, said racing scoring game specifying receiving a maximum stable value for an aggregated plurality of pre-race salary values and an nth horse selection, the non-transitory computer readable medium comprising:
instructions for receiving, via a network, pre-race odds for a plurality of horses across a plurality of races;
instructions for determining on a computer processor associated with said network, and for each of said plurality of horses, a pre-race salary value and a stable of horses for a racing event by applying said pari-mutuel wagering;
instructions for receiving on said computer processor associated with said network a rules selection for a given game, said rules selection specifying at least:
said maximum stable value for said aggregated plurality of pre-race salary values; and
said nth horse selection;
for a first participant, instructions for receiving a first participant first horse selection through a first participant nth horse selection;
for said nth participant, instructions for receiving an nth participant first horse selection through an nth participant nth horse selection;
instructions for receiving on said computer processor associated with said network race results via a network connection;
instructions for determining from said race results, on said computer processor associated with said network, a score value for each of said plurality of horses across said plurality of races;
instructions for determining on said computer processor associated with said network, for said first participant, an aggregated score value for a first participant stable;
instructions for determining on said computer processor associated with said network, for said nth participant, an aggregated score value for said nth participant stable; and
instructions for determining on said computer processor associated with said network a highest value stable selected from said first participant stable and said nth participant stable.

16. The computer readable medium of claim 15, further comprising instructions stored on said non-transitory computer readable medium for awarding finishing position points according to a finishing position of horses in a given race.

17. The non-transitory computer readable medium of claim 15, further comprising instructions stored on said non-transitory computer readable medium for adjusting scores derived from the finishing position points according to horse finishing margins.

18. The non-transitory computer readable medium of claim 15, further comprising instructions stored on said non-transitory computer readable medium for deriving horse salaries by converting odds of horses to salaries for a given race.

19. The non-transitory computer readable medium of claim 15, further comprising instructions stored on said non-transitory computer readable medium for scoring horse racing results according to finishing position and finishing margins.

20. The non-transitory computer readable medium of claim 15, further comprising instructions stored on said non-transitory computer readable medium for calculating stable point values for a participant stable upon finishing each race in a racing event.
